(19) United States
(12) Patent Application Publication
(10) Pub. No.: US 2025/0060825 A1
(43) Pub. Date: Feb. 20, 2025

(54) VIBRATION SIGNAL ENCODING PROCESSING METHOD AND APPARATUS, COMPUTER DEVICE, AND STORAGE MEDIUM

(71) Applicant: TENCENT TECHNOLOGY (SHENZHEN) COMPANY LIMITED, Shenzhen (CN)

(72) Inventors: Hao WANG, Shenzhen (CN); Shili XU, Shenzhen (CN); Yajun ZHANG, Shenzhen (CN); Xun SUN, Shenzhen (CN)

(73) Assignee: TENCENT TECHNOLOGY (SHENZHEN) COMPANY LIMITED, Shenzhen (CN)

(21) Appl. No.: 18/933,466

(22) Filed: Oct. 31, 2024

Related U.S. Application Data
(63) Continuation of application No. PCT/CN2023/079126, filed on Mar. 1, 2023.

(30) Foreign Application Priority Data
Jun. 16, 2022 (CN) 202210684720.9

(51) Int. Cl. G06F 3/01; G06F 3/04886

(52) U.S. Cl. CPC G06F 3/016; G06F 3/04886; G06F 2203/014

(57) ABSTRACT

A vibration signal encoding processing method and apparatus, a computer device, and a storage medium, capable of obtaining a plurality of control elements in a target device, determining layout information of the plurality of control elements in the target device according to a device position of any control element of the plurality of control elements in the target device, determining scenario indication information corresponding to the plurality of control elements according to an expression form used by the target device to perform content output based on the plurality of control elements, determining orientation indication information of any control element based on the layout information, and performing vibration signal encoding on each of the plurality of control elements based on the scenario indication information and the orientation indication information to obtain vibration signal encoding information corresponding to each of the plurality of control elements.

### CROSS-REFERENCE TO RELATED APPLICATIONS

This application is a continuation application of International Application No. PCT/CN2023/079126 filed on Mar. 1, 2023, which claims priority to Chinese Patent Application No. 202210684720.9, filed with the China National Intellectual Property Administration on Jun. 16, 2022, the disclosures of each being incorporated by reference herein in their entireties.

### FIELD

The disclosure relates to the field of computer technologies, and in particular, to a vibration signal encoding processing method and apparatus, a computer device, and a storage medium.

### BACKGROUND

With continuous development of a computer technology, convenience of relevant users in production and daily life processes can be effectively improved by performing content output based on a computer device. Due to diversity of output content based on the computer device at present, diversified forms of content output have also emerged, such as voice output or text output, all of which are intended to better satisfy device use needs of the users.

### SUMMARY

Some embodiments provide a vibration signal encoding processing method, including: obtaining a plurality of control elements in a target device, and determining layout information of the plurality of control elements in the target device according to a device position of any control element of the plurality of control elements in the target device; determining scenario indication information corresponding to the plurality of control elements according to an expression form used by the target device to perform content output based on the plurality of control elements, and determining orientation indication information of any control element based on the layout information, the expression form comprising a digit form, a letter form, and a character form, the scenario indication information indicating an expression form of output content of a corresponding control element and the orientation indication information indicating a relative position of the corresponding control element; and performing vibration signal encoding on each of the plurality of control elements based on the scenario indication information and the orientation indication information to obtain vibration signal encoding information corresponding to each of the plurality of control elements, the vibration signal encoding information indicating a vibration mode of a vibration motor of the computer device.

Some embodiments provide a vibration signal encoding processing apparatus, including: at least one memory configured to store program code; and a least one processor configured to read the program code and operate as instructed by the program code, the program code comprising: obtaining code configured to cause at least one of the at least one processor to obtain a plurality of control elements in a target device, and determine layout information of the plurality of control elements in the target device according to a device position of any control element of the plurality of control elements in the target device; and processing code configured to cause at least one of the at least one processor to: determine scenario indication information corresponding to the plurality of control elements according to an expression form used by the target device to perform content output based on the plurality of control elements, and determine orientation indication information of any control element based on the layout information, the expression form comprising a digit form, a letter form, and a character form, the scenario indication information indicating an expression form of output content of a corresponding control element and the orientation indication information indicating a relative position of the corresponding control element; and perform vibration signal encoding on each of the plurality of control elements based on the scenario indication information and the orientation indication information to obtain vibration signal encoding information corresponding to each of the plurality of control elements, the vibration signal encoding information indicating a vibration mode of a vibration motor of a computer device.

Some embodiments provide a non-transitory computer-readable storage medium storing computer code which, when executed by at least one processor, causes the at least one processor to at least: obtain a plurality of control elements in a target device, and determine layout information of the plurality of control elements in the target device according to a device position of any control element of the plurality of control elements in the target device; determine scenario indication information corresponding to the plurality of control elements according to an expression form used by the target device to perform content output based on the plurality of control elements, and determine orientation indication information of any control element based on the layout information, the expression form comprising a digit form, a letter form, and a character form, the scenario indication information indicating an expression form of output content of a corresponding control element and the orientation indication information indicating a relative position of the corresponding control element; and perform vibration signal encoding on each of the plurality of control elements based on the scenario indication information and the orientation indication information to obtain vibration signal encoding information corresponding to each of the plurality of control elements, the vibration signal encoding information indicating a vibration mode of a vibration motor of a computer device.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of a vibration waveform according to some embodiments.

FIG. 2 is a schematic diagram of a grid layout according to some embodiments.

FIG. 3 is a schematic flowchart of a vibration signal encoding processing method according to some embodiments.

FIG. 4 is a schematic diagram of a dot matrix element according to some embodiments.

FIG. 5 is a schematic diagram of a control element according to some embodiments.

FIG. 6 is a schematic diagram of a prefix waveform according to some embodiments.

FIG. 7 is a schematic diagram of a suffix waveform according to some embodiments.

FIG. 8 is a schematic diagram of a vibration waveform of an anchor element according to some embodiments.

FIG. 9 is a schematic diagram of vibration signal encoding information of a grid according to some embodiments.

FIG. 10 is a schematic diagram of a vibration waveform of a non-anchor element according to some embodiments.

FIG. 11 is a schematic diagram of vibration signal encoding information of a complete grid according to some embodiments.

FIG. 12 is a schematic diagram of vibration signal encoding information of an operation handle according to some embodiments.

FIG. 13 is a schematic diagram of an output vibration according to some embodiments.

FIG. 14 is a schematic block diagram of a vibration signal encoding processing apparatus according to some embodiments.

FIG. 15 is a schematic block diagram of a computer device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Some embodiments provide a vibration signal encoding processing method and apparatus, a computer device, and a storage medium, which can enhance flexibility of vibration signal encoding for a control element.

Some embodiments provide a vibration signal encoding processing method, so that a computer device may determine scenario indication information when vibration signal encoding is performed on various control elements based on an expression form used by each control element in a target device to perform content output. Orientation indication information of any control element is further determined based on layout information of the various control elements in the target device. The computer device generates vibration signal encoding information for any control element based on the determined scenario indication information and orientation indication information. Therefore, the target device outputs content corresponding to the control element and synchronously outputs the vibration signal encoding information corresponding to the control element when subsequently performing content output based on the control element. Therefore, a corresponding device user may determine the content correspondingly output by the target device based on the vibration signal encoding information output by the target device, which improves flexibility and diversity when the device user determines the output content.

In addition, the target device performs vibration signal encoding based on the orientation indication information and the scenario indication information, and the orientation indication information is fixed information determined based on an orientation corresponding to the control device. Therefore, by a method for performing vibration signal encoding on the control element in some embodiments, the scenario indication information may be flexibly adjusted based on a change of a scenario, and a vibration signal encoding method corresponding to the orientation indication information does not need to be adjusted, which reduces learning cost when the computer device performs vibration signal encoding on the control element, and improves flexibility of vibration signal encoding of the computer device.

In some embodiments, the control element in the target device may refer to a physical control key, may refer to a virtual touch button, or the like. No limits are made thereto. The computer device may be the target device, may be a built-in processor in the target device, may be an external device connected to the target device, or the like. No limits are made thereto. In addition, both the computer device and the target device may be servers or terminal devices. In some embodiments, a detailed description is mainly provided using an example where the computer device and the target device are terminal devices.

In some embodiments, there may be one or more corresponding expression forms when the control element performs content output. The expression form may be a digit form, a letter form, a character form, or the like, for example, after digit 5 in a grid keyboard is selected, corresponding output content may be the digit 5, may be any one of corresponding letters j, k, or 1, may be a character generated by a corresponding letter, or the like. Corresponding scenario indication information when vibration signal encoding is performed on the control element is configured for indicating an expression form of output content of a corresponding control element. For example, scenario indication information 1 may be configured for expressing the output content in the digit form, and scenario indication information 2 may be configured for expressing the output content in the letter form.

In some embodiments, an operation of performing vibration signal encoding on various control elements refers to: determining a tactile reminder when corresponding output content is output after the various control elements are selected. The tactile reminder may be a vibration reminder, a flash reminder, or the like. The vibration signal encoding refers to determining a vibration waveform corresponding to the control element. The vibration waveform is configured for reminding the output content corresponding to the control element. If the control element is a physical key, and the corresponding output content is digit 2, the vibration waveform configured for reminding the digit 2 from a tactile sense may be determined through vibration signal encoding. In some embodiments, the tactile reminder specifically refers to the vibration reminder. A process of performing vibration signal encoding on the various control elements in some embodiments is a process of determining accompanying vibration waveforms corresponding to vibration reminders when the various control elements output corresponding output content. In some embodiments, performing vibration signal encoding on the control element is to determine an accompanying vibration waveform when the corresponding control element performs content output. The scenario indication information may be different vibration waveforms, so that different vibration waveforms may be configured for performing tactile feedback in a case that the corresponding control element outputs the output content in different expression forms, which can improve rationality and practicality after vibration signal encoding is performed on the various control elements, and is helpful to improve user stickiness of the control element after vibration signal encoding.

In some embodiments, disabled groups such as visually impaired users, hearing impaired users, physically disabled users, or users with visual, auditory, or physical limitations currently (for example, a user who is cooking may be understood as a visually limited user) usually have impediments when obtaining information transmitted by a single sense organ due to lack of a sense organ during using the computer device, leading to that a corresponding user cannot obtain complete information from the computer device. Based on lack of obtained information, various difficulties may usually be caused when the corresponding user uses the computer device. Therefore, to improve an audience user range of the computer device, the computer device usually does not only output a single piece of sensory information to achieve information transmission. For example, to avoid that a visually impaired user cannot obtain complete visual information from the computer device, the computer device usually outputs corresponding audio information when outputting visual information, so that the visually impaired user may obtain complete output information from the computer device through the corresponding audio information. An accessibility concept advocates that transmission of any information does not rely on a single sense organ, that is to say, the computer device needs to perform output and transmission on information in a plurality of sensory forms for output of the same information. For example, picture information may be accompanied by text descriptions, so as to facilitate reading by the visually impaired user through a screen; and the audio information may be accompanied by converted text information, so as to ensure obtaining of the complete information by a hearing impaired user. In some embodiments, diversity of transmitting information currently is mainly achieved through a tactile feedback technology.

In five senses of a human body, a tactile sense has a wider contact surface with our bodies compared with other senses. There are receivers of tactile signals all over the human body. Even though, information that the tactile sense of the human body can transmit is limited, and is usually only 1% of the visual information. However, emotional experiences that the tactile sense brings to humans are indispensable. If there is no tactile sense, a process that a user interacts with a real object in daily life will become dull and uninteresting. It is the same with technical products. For virtual reality (VR) somatosensory game consoles and terminal devices for daily use (for example, a smartphone), tactile feedback brought by vibration improves user experience. That is to say, the tactile feedback may effectively compensate for an existing information transmission method at present, and bring more diversified operating experiences to a device user corresponding to the computer device. Based on flexibility and privacy of the tactile feedback, diversity of the output information achieved based on the tactile feedback better satisfies user needs. The tactile feedback of the computer device involved in some embodiments is to drive a motor to vibrate in a mode indicated by vibration signal encoding information after the corresponding vibration signal encoding information (i.e., a vibration waveform) is determined. Due to continuous iteration and upgrading of vibration motor technologies of computer devices, performance of vibration modules is constantly improved, and a more comfortable experience is brought. Computer devices have also basically opened up application programming interfaces (APIs) of systems, so that a large number of third-party users (for example, vibration developers) are enable to use vibration feedback to improve product experiences, and different vibration waveforms may be generated through different strengths, frequencies, and times. Different application scenarios are distinguished and expressed by using different vibration waveforms, so that the computer device achieves an accompanying reminder for an application scenario through an accompanying output vibration when outputting a reminder message corresponding to the vibration signal encoding information.

In some embodiments, adapted models and systems of the APIs are not completely the same. A most suitable API is to be selected according to covered systems and models in a product implementation, and then a suitable tactile feedback effect is designed according to a scenario. The APIs of vibrations with default values provided by a current iPhone operating system (iOS) (an operating system) is shown in Table 1:

TABLE 1

| API | Parameter | Remark |
|---|---|---|
| Vibration | AudioServicesPlaySystemSound(kSyst | A vibration lasts for 1 s at a high |
| | emSoundID_Vibrate) | frequency, and is usually configured |
| | | for message notification. |
| TapticEngine | a. Peek tactile sense | Commonly configured for three- |
| | AudioServicesPlaySystemSound(1519 | dimensional (3D) touch. Pop has a |
| | ) | slightly stronger vibration than |
| | b. Pop tactile sense | Peek. |
| | AudioServicesPlaySystemSound(1520 | Scenario: a. Long press or repress a |
| | ) | particular control item in a control |
| | c. Three continuous short vibrations | center; and b. Enlarge a menu to a |
| | (three continuous vibrations of Peek | page. |
| | tactile sense) | |
| | AudioServicesPlaySystemSound(1521 | |
| | ) | |
| UIImpactFeedbackGenerator | a. Light (representing a physical | Commonly configured for |
| | vibration or an interaction of a small | dropdown refresh and gesture |
| | interface element) | feedback; |
| | UIImpactFeedbackGenerator*generato | Scenario: Clock adjustment, clock |
| | r = | scale, and on and off of a switch |
| | [UIImpactFeedbackGeneratoralloc] | control. |
| | initWithStyle:UIImpactFeedbackStyle | |
| | Light]; | |
| | b. Medium (representing a physical | |
| | vibration or an interaction of a medium | |
| | sized interface element) | |
| | UIImpactFeedbackGenerator*generato | |
| | r=[[UIImpactFeedbackGeneratoralloc] | |
| | initWithStyle:UIImpactFeedbackStyle | |
| | Light]; | |
| | c. Heavy (representing a physical | |
| | vibration or an interaction of a large | |
| | interface element) | |
| | UIImpactFeedbackGenerator*generato | |
| | r = | |
| | [UIImpactFeedbackGeneratoralloc] | |
| | init WithStyle:UIImpactFeedbackStyle | |
| | Heavy]; | |
| UINotificationFeedbackGenerator | a. Success (representing completion of | Scenario: a. Face recognition |
| | a task or a behavior) | success; b. Shake revocation; c. |
| | UINotificationFeedbackGenerator*not | Face recognition failure, and |
| | ificationFeedbackGenerator=[[UINotif | password input error after screen |
| | icationFeedbackGeneratoralloc]init] | lock. |
| | [notificationFeedbackGeneratornotific | |
| | ationOccurred:UINotificationFeedback | |
| | TypeSuccess] | |
| | b. Warning (representing that a | |
| | warning is generated when a task or | |
| | behavior is performed) | |
| | UINotificationFeedbackGenerator*not | |
| | ificationFeedbackGenerator=[[UINotif | |
| | icationFeedbackGeneratoralloc]init] | |
| | [notificationFeedbackGeneratornotific | |
| | ationOccurred:UINotificationFeedback | |
| | TypeWarning] | |
| | c. Failure: Error (representing failure | |
| | of a task or a behavior) | |
| | UINotificationFeedbackGenerator*not | |
| | ificationFeedbackGenerator=[[UINotif | |
| | icationFeedbackGeneratoralloc]init] | |
| UISelectionFeedbackGenerator | UISelectionFeedbackGenerator*selecti | Scenario: After dropping down a |
| | onFeedbackGenerator = | browser, swipe left and right to |
| | [[UISelectionFeedbackGeneratoralloc] | select an option or a photo, or a |
| | init] | picture is enlarged to a limit value |
| | [selectionFeedbackGeneratorselection | and bounces back after being |
| | Changed] | continuously enlarged. |

In some embodiments, a suitable vibration effect can be easily combined by calling the APIs with default values described above, as long as the called API, a type, and a time interval between every two vibrations are marked. In addition, the tactile feedback can transmit much less information than a visual sense and an auditory sense, and will not be a main means for information transmission, so the information only serves as supplementary information (or enhanced information) to visual information and auditory information. The tactile feedback generated by the vibration motor of the computer device can effectively improve the sensibility of an interaction and enhance user experience. For example, in a case of information transmission, the tactile feedback usually has two functions:
(1) prompting whether an operation result occurs (the visual sense and the auditory sense may be insufficient or cannot be timely transmitted to the user); and
(2) implicitly expressing a nature of the operation result.

For example, the design of vehicle software needs to consider the factors such as that operation personnel cannot focus visual attention on the interface and there are various noise interferences in a road environment. In this case, tactile information generated by a vibration can compensate for deficiencies of the visual information and the auditory information, and inform the operation personnel whether the operation result occurs. In addition, the computer device establishes different physical metaphors by setting different changes of an amplitude and a frequency, so as to bring different feelings to the operation personnel. For example, a default API (an application programming interface) may be built-in the computer device, including three types of preset vibration feedback, i.e., success, failure, and warning, which respectively correspond to natures of results. For example, waveforms corresponding to the three types of vibration feedback are as shown in FIG. 1. For example, a waveform of vibration feedback corresponding to success (for example, may be a vibration waveform marked by (1) in FIG. 1) is a waveform with an amplitude from low to high to transmit a positive signal, which implicitly expresses that this operation result is success. For example, in a recognition success scenario, the computer device may output a corresponding waveform of the vibration feedback corresponding to success. A waveform of the vibration feedback corresponding to warning (for example, may be a vibration waveform marked by (2) in FIG. 1) is a waveform with an amplitude from high to low to transmit a negative signal, indicating that this operation has a risk, and needs to be performed after being confirmed. In addition, a waveform of the vibration feedback corresponding to failure (for example, may be a vibration waveform marked by (3) in FIG. 1) is a waveform with an amplitude that increases first and then decreases and a frequency that increases, indicating that this operation result is failure. In a scenario of recognition failure or operation failure, the waveform of the vibration feedback corresponding to failure is output.

In some embodiments, the computer device, when performing vibration signal encoding on a control element, further determines layout information of various control elements in a target device in addition to determining scenario indication information based on an expression form of the control element, so as to determine orientation indication information when vibration signal encoding is performed on a corresponding control element based on the layout information. The computer device performs vibration signal encoding in combination with the scenario indication information and the orientation indication information for vibration signal encoding of the various control elements in the target device. Based on vibration signal encoding performed in combination with the scenario indication information and the orientation indication information, when a reminder (for example, the tactile feedback described above, specifically, the vibration output described above) is output based on vibration signal encoding information subsequently, a user may determine accompanying output content based on the output reminder. Moreover, vibration signal encoding in combination with the scenario indication information and the orientation indication information can further effectively improve accuracy of the vibration signal encoding information obtained by performing vibration signal encoding on the various control elements by the computer device, can improve correlation between the vibration signal encoding information obtained by performing vibration signal encoding on the various control elements and a corresponding layouts of the various control elements and between the vibration signal encoding information and expression forms, and is helpful to improve comprehensibility of the reminder corresponding to the output vibration signal encoding information.

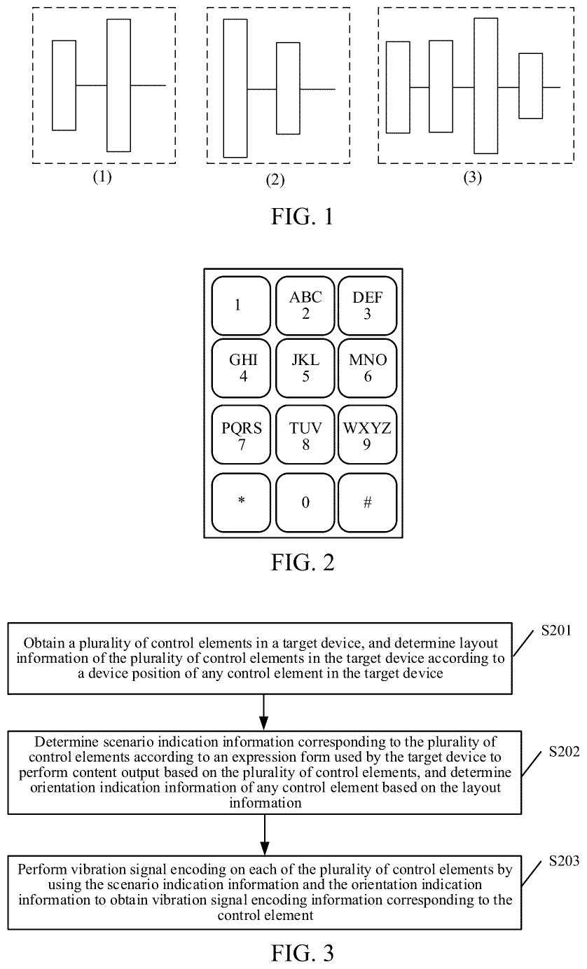

The layout information of the various control elements in the target device may be determined based on positions of the various control elements in the target device. The layout information in some embodiments may refer to a grid shown in FIG. 2. In addition, when the layout information is not a grid, but the various control elements have a corresponding position relationship, a method for performing vibration signal encoding on the corresponding control element may also be referred to.

FIG. 3 is a schematic flowchart of a vibration signal encoding processing method according to some embodiments. As shown in FIG. 3, the method may include the following operations:

S201: Obtain a plurality of control elements in a target device, and determine layout information of the plurality of control elements in the target device according to a device position of any control element in the target device.

S202: Determine scenario indication information corresponding to the plurality of control elements according to an expression form used by the target device to perform content output based on the plurality of control elements, and determine orientation indication information of any control element based on the layout information.

In operation S201 and operation S202, the target device may be a smart terminal, a traditional telephone, or the like. When the target device is the smart terminal, the plurality of control elements in the target device may be touch buttons in the smart terminal. When the target device is the traditional telephone, the plurality of control elements in the target device may be physical keys of the traditional phone. In addition, in some embodiments, the computer device and the target device may be considered as the same device.

In some embodiments, positions (relative positions) of various control elements in the target device are fixed in the target device. Therefore, the computer device may determine the layout information of the plurality of control elements in the target device based on the positions of the control elements in the target device. The layout information may reflect device positions of the various control elements in the target device. Meanwhile, the layout information may reflect a relative position relationship between different control elements in the target device.

A process that the computer device determines the layout information of the plurality of control elements in the target device is a background processing process of the computer device. That is to say, whether to output or display the control element is irrelevant in a process that the computer device obtains the layout information of the control elements. In some embodiments, when the computer device obtains the layout information, the control element may not be displayed, or the control element may be displayed. No limits are made herein.

In some embodiments, the plurality of control elements included in the target device may be dot matrix elements, for example, the dot matrix elements included in the physical keys of the target device. The dot matrix elements are configured for expressing information for a user with a visual impairment. Generally, a dot matrix element is generally formed by dot elements of a square. Each dot performs tactile information feedback through a protrusion or an indentation, so as to achieve expressions of at most 64 types of information.

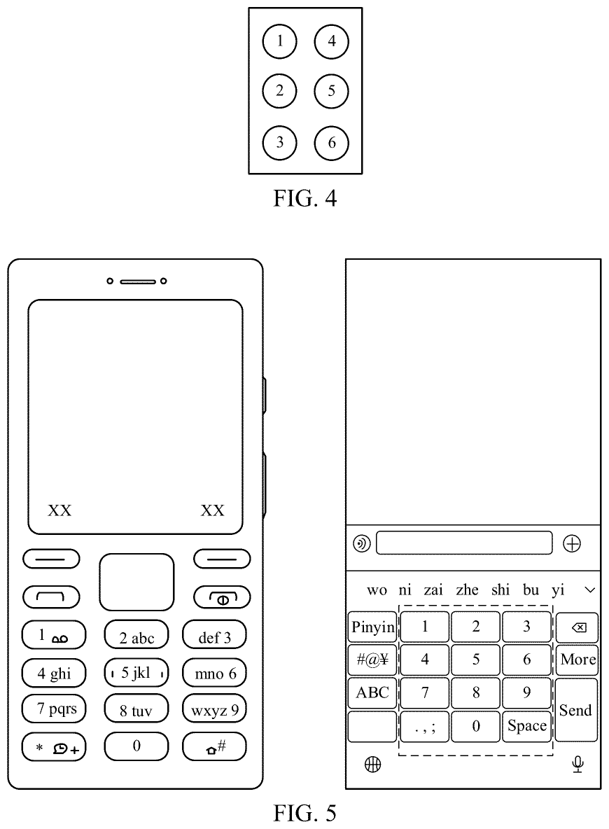

In some embodiments, when the control elements included in the target device are dot matrix elements, the layout information of the dot matrix elements in the target device may be determined based on the positions of six dot elements of the dot matrix elements in the square. As shown in FIG. 4, the layout information of the dot matrix elements is that: Six dot elements form a group of dot matrix elements, and six dots of the group of dot matrix elements are fixed in positions, are arranged in a sequence of 1, 2, and 3 from top to bottom on a left side, and are arranged in a sequence of 4, 5, and 6 from top to bottom on a right side. For example, a group of dot matrix elements may represent 26 English letters. First ten letters (a-j) only use four dots, i.e., 1, 2, 4, and 5, a is represented by dot 1, b is represented by dot 1 and dot 2, c is represented by dot 1 and dot 3, and so on. Subsequent ten letters (k-t) are obtained by adding dot 3 to (a-j), the final six letters (u-z), except for “w”, are all obtained by adding dot 3 and dot 6 to (a-j), and letter w is obtained by adding dot 6 to j. For another example, the dot matrix elements described above may represent digits by adding prefixes. The prefixes may be highlighting of dot 3 to dot 6. The highlight of dot 1 represents digit 1, the highlight of dot 1 and dot 2 represents digit 2, the highlight of dot 1 and dot 4 represents digit 3, the highlight of dot 1, dot 4, and dot 5 represents digit 4, the highlight of dot 1 and dot 5 represents digit 5, and so on.

Based on arrangement of various dot elements in the dot matrix elements and two element states, i.e., the protrusion and the indentation corresponding to each dot element, the computer device may define vibration signal encoding information of the dot matrix elements corresponding to different output content based on the element states of the various dot elements in the dot matrix elements. The computer device may determine scenario indication information of each dot element in the dot matrix elements first based on an expression form of the output content.

In some embodiments, the expression form of the output content includes: a letter form, a digit form, and a Chinese form. Therefore, the computer device will determine the scenario indication information corresponding to the letter form, the scenario indication information corresponding to the digit form, and the scenario indication information corresponding to the Chinese form respectively. After the computer device determines corresponding scenario indication information when the various dot elements express the output content in different forms, further, the computer device may determine orientation indication information of each dot element in combination with the layout information of the various dot elements in the dot matrix elements. The computer device may perform vibration signal encoding based on the scenario indication information and the orientation indication information corresponding to each dot element to obtain vibration signal encoding information corresponding to the dot element, and then output, when outputting output content corresponding to each dot element (or the dot matrix element), tactile reminder information corresponding to corresponding output content based on the vibration signal encoding information corresponding to the dot element.

Practice shows that a user may not be able to perceive vibration effects with similar parameters, that is to say, a resolution that the user can perceive needs to be considered when a vibration effect is designed. Correspondingly, a plurality of parameter benchmark values are set, for example, three frequency levels may be set: 15-45-75 Hz, or a plurality of strength levels are set, for example, strength levels are set as 20-40-70-100, or the computer device may select a value based on a resolution corresponding to tactile information in an absence of a guidance of a frequency benchmark or a strength benchmark, so that a receiving user corresponding to the tactile information may clearly perceive a change of the tactile information. That is to say, the receiving user corresponding to the tactile information may determine a change of strength of two times of tactile information through the values of different frequencies and/or strengths.

In some embodiments, the plurality of control elements in the target device are touch buttons or physical keys in the target device, as shown in FIG. 5. Some embodiments are mainly described in detail in a case that various control elements are arranged in the target device in a grid layout. That is to say, the layout information obtained by the computer device based on device positions of the various control elements in the target device is the grid. The grid generally refers to a layout that the control elements are arranged in a mode of 3×3 rows and columns, or the grid may refer to a layout that the control elements are arranged in a mode of n×3 rows and columns, n is greater than 3, for example, the control elements are arranged in a mode of 4×3 or 5×3 rows and columns. For the plurality of control elements that are in the grid layout, when performing vibration signal encoding on a corresponding control element, the computer device may determine a corresponding expression form used by each control element to perform content output first to determine scenario indication information based on the expression form, and then perform vibration signal encoding on the control element in combination with the scenario indication information and orientation indication information corresponding to the layout information. Then operation S203 may be performed.

S203: Perform vibration signal encoding on each of the plurality of control elements by using the scenario indication information and the orientation indication information to obtain vibration signal encoding information corresponding to the control element.

In some embodiments, if a purpose of performing vibration signal encoding on various control elements is to determine a corresponding vibration waveform when the corresponding control element performs content output, the computer device may respectively express the scenario indication information and the orientation indication information by using two different vibration waveforms when performing vibration signal encoding on each control element by using the scenario indication information and the orientation indication information.

From the grid layout shown in FIG. 5, it may be learned that digit 5 (i.e., a central button of the grid) is located at a central position of the grid layout. Buttons in up, down, left, and right position relationships with the button corresponding to the central position include buttons with digits 2, 4, 6, and 8, buttons in a 45° diagonal relationship with the central position respectively include buttons with digits 1, 3, 7, and 9, and buttons with digits 0, *, and # are indirectly related to the central position.

In some embodiments, the control elements in the grid layout refer to elements that have corresponding output content, while the control elements that do not have corresponding output content, for example, operation buttons (specifically, switching buttons) are not taken into consideration when element layout is considered. That is to say, for a plurality of touch buttons shown in FIG. 5, the control elements in the grid layout refer to the touch buttons that have corresponding output buttons outlined by dashed lines in FIG. 5. The buttons in the 45° diagonal relationship with the central position may be understood as buttons in special up, down, left, and right position relationships.

Based on a special orientation relationship among various control elements in the grid, the computer device may express the scenario indication information by using a prefix waveform, which is configured for informing a user of an expression type (a digit, a character, or the like) of the output content expressed by a subsequent vibration. Then, a suffix waveform for expressing the layout information corresponding to the corresponding control element is determined based on a special relationship between positions of various control elements in the grid layout and the central position. Then, the vibration waveform of the corresponding control element may be determined based on the prefix waveform and the suffix waveform. The vibration signal encoding information of each control element is obtained after the vibration waveform of the control element is determined. That is to say, if the computer device expresses the scenario indication information by using the prefix waveform and expresses the orientation indication information by using the suffix waveform, the computer device may generate one or more combined waveforms in a mode of combining the prefix waveform and the suffix waveform when performing vibration signal encoding on each control element by using the scenario indication information and the orientation indication information. The computer device may associate one combined waveform with one control element, and the combined waveform associated with the control element may be used as a vibration waveform of the corresponding control element.

In some embodiments, there is at least one prefix waveform and at least one suffix waveform set in the computer device. Different prefix waveforms may correspondingly express output content in different expression forms, and different suffix waveforms may be configured for expressing position information corresponding to the corresponding control element (or a relative position relationship between the corresponding control element and other control elements).

In some embodiments, the computer device may select a target prefix waveform from at least one prefix waveform first when generating the combined waveform based on a combination of the prefix waveform and the suffix waveform. For the purpose that the selected target prefix waveform can effectively express the scenario information when a current control element performs content output, the computer device may select, from the at least one prefix waveform, a target prefix waveform that matches the expression form used by the target device to perform content output as the target prefix waveform when selecting the target prefix waveform from the at least one prefix waveform. In some embodiments, the computer device also selects a target suffix waveform from at least one suffix waveform in addition to obtaining the target prefix waveform from the at least one prefix waveform. Then, the computer device may combine the selected target prefix waveform and target suffix waveform to generate a target combined waveform. The target combined waveform is to be used as a vibration waveform corresponding to a particular control element.

In some embodiments, after the target prefix waveform and the target suffix waveform obtained by the computer device are combined, generated combined waveforms need to be in one-to-one correspondence with the control elements included in the target device to achieve effective expressions of various control elements in the target device, and the computer device may obtain a total element quantity corresponding to a plurality of control elements, so that a waveform quantity N of required target prefix waveforms and a waveform quantity M of required target suffix waveforms may be determined according to the total element quantity. Both N and M are positive integers, and then the computer device may obtain N target prefix waveforms from the at least one prefix waveform, and obtain M target suffix waveforms from the at least one suffix waveform. After the N target prefix waveforms are combined with the M target suffix waveforms, the quantity of the obtained combined waveforms is greater than or equal to the total element quantity, so as to ensure that one control element in the target device may correspond to one combined element generated according to the target prefix waveform and the target suffix waveform.

For example, when the total element quantity of the plurality of control elements obtained by the computer device is 12 as shown in FIG. 5, the computer device may respectively obtain 2 target prefix waveforms and 6 target suffix waveforms to combine to obtain 12 combined waveforms to obtain a vibration waveform corresponding to each control element.

In some embodiments, if the computer device only obtains one basic prefix waveform for indicating an expression form of current output content, and obtains M target suffix waveforms, the computer device may further randomly combine the M target suffix waveforms and the basic prefix waveform to obtain combined reference waveforms. If a quantity of the combined reference waveforms obtained by the computer device is greater than or equal to the total element quantity, one obtained combined reference waveform is associated with one control element. Different control elements are associated with different combined reference waveforms.

In some embodiments, if the quantity of the combined reference waveforms obtained by the computer device is less than the total element quantity of the plurality of control elements, the computer device may further perform split processing on the basic prefix waveform according to the total element quantity and the waveform quantity M of the target suffix waveforms to obtain N split waveforms. A quantity of the combined waveforms obtained by combining the N split waveforms and the M target suffix waveforms is greater than or equal to the total element quantity, N is greater than 1, and N is an integer. The N split waveforms are used as the target prefix waveforms.

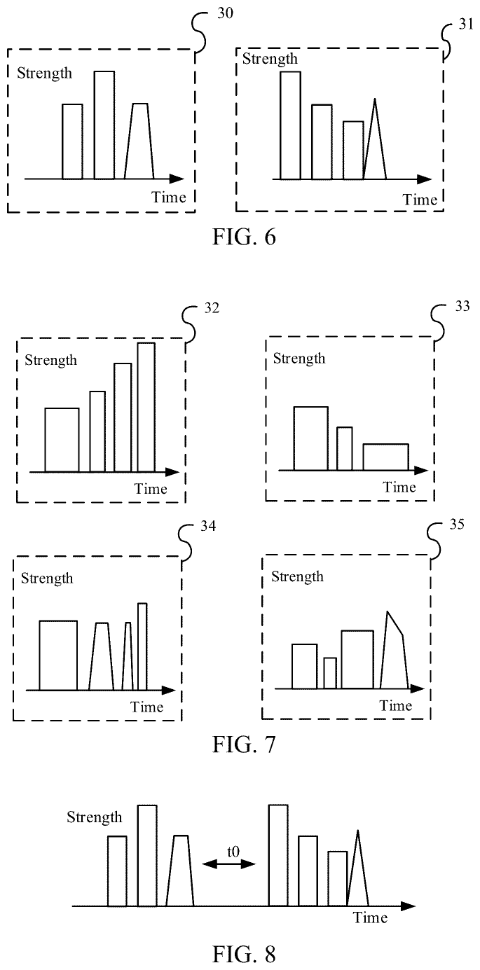

In some embodiments, in a case that the plurality of control elements are in a grid layout, the computer device may use two vibration waveforms with different vibration effects as target prefix waveforms. These two vibration waveforms with different vibration effects are configured for indicating the output content in the same expression form. In addition, these two vibration waveforms with different vibration effects may be obtained by performing splitting processing on one vibration waveform, or may be two different independent vibration waveforms. The target prefix waveforms with two different vibration effects obtained by the computer device may include a first prefix waveform and a second prefix waveform. The first prefix waveform is a vibration waveform with a vibration strength that increases gradually, and specifically, may be the vibration waveform marked by 30 in FIG. 6; and the second prefix waveform is a vibration waveform with a vibration strength that decreases gradually, and specifically, may be the vibration waveform marked by 31 in FIG. 6.

In some embodiments, the control element that is located at the central position among the plurality of control elements in the grid layout may be considered as an anchor element of the plurality of control elements in the grid layout, while other control elements that are located at other positions in the grid are non-anchor elements. When the control elements are in the grid layout, the corresponding central position is a position in a second row and a second column from bottom to top and from left to right, the control element corresponding to the central position is an anchor element, so the central position may also be referred to as an anchor position. Based on the grid layout of the plurality of control elements, the non-anchor elements, except for the anchor element, include non-anchor elements directly related to the anchor element. The non-anchor elements directly related to the anchor element may be understood as those have up, down, left, and right position relationships with the anchor element, and one suffix waveform set in the computer device may be configured for expressing one reference position relationship. So, the computer device may respectively set the suffix waveforms with the reference position relationships of up, down, left, and right.

In some embodiments, the computer device may express two position relationships of up and down by using the vibration waveforms that increase gradually and decrease gradually, express a left orientation relationship by using a vibration waveform with a frequency that decreases gradually, and express a right orientation relationship by using a waveform with a frequency that increases gradually. When the reference position relationships include one or more of an up orientation, a down orientation, a left orientation, and a right orientation, the at least one suffix waveform in the computer device includes: a suffix waveform corresponding to any one of the up orientation, the down orientation, the left orientation, and the right orientation. A vibration strength of the suffix waveform corresponding to the up orientation gradually increases, as shown in the vibration waveform marked by 32 in FIG. 7. A vibration strength of the suffix waveform corresponding to the down orientation gradually decreases, as shown in the vibration waveform marked by 33 in FIG. 7. A vibration frequency of the suffix waveform corresponding to the left orientation gradually decreases, as shown in the vibration waveform marked by 34 in FIG. 7. A vibration frequency of the suffix waveform corresponding to the right orientation gradually increases, as shown in the vibration waveform marked by 35 in FIG. 7.

In some embodiments, based on division of the anchor element and the non-anchor elements in the grid layout by the computer device, the computer device may select the target prefix waveform from the at least one prefix waveform after determining the anchor element and the non-anchor elements in the plurality of control elements when selecting the target prefix waveform and the target suffix waveform. The target suffix waveform is selected from the at least one suffix waveform based on an orientation relationship between the anchor element and the non-anchor elements. The computer device selects a suffix waveform with a corresponding reference position relationship that is the same as the orientation relationship from the at least one suffix waveform based on the orientation relationship between the anchor element and the non-anchor elements. The selected suffix waveform is the target suffix waveform.

In some embodiments, after selecting the target prefix waveform and the target suffix waveform, when combining to generate the target combined waveform based on the target prefix waveform and the target suffix waveform, in a case that a target control element that generates the vibration waveform is the anchor element, the computer device may combine the target prefix waveform based on a first time interval to generate the target combined waveform of the target control element. When the target control element that generates the vibration waveform is the anchor element, the computer device obtains the first prefix waveform and the second prefix waveform in the at least one prefix waveform included in the target prefix waveform. Assuming that the first time interval is represented by t0, and is generally set as 100 ms, the target combined waveform of the target control element generated after the first prefix waveform and the second prefix waveform are combined based on the first time interval is as shown in FIG. 8. When determining that a target control element that generates the vibration waveform is the non-anchor element, the computer device combines the target prefix waveform and the target suffix waveform based on a second time interval to generate the target combined waveform of the target control element. One prefix waveform is obtained, i.e., the target prefix waveform, and one suffix waveform is obtained, i.e., the target suffix waveform. The target combined waveform of the target control element is generated by combining the one obtained target prefix waveform and the one obtained target suffix waveform. In some embodiments, the second time interval may be the same as or may be different from the first time interval, and the second time interval may be represented by t0 when the second time interval is the same as the first time interval.

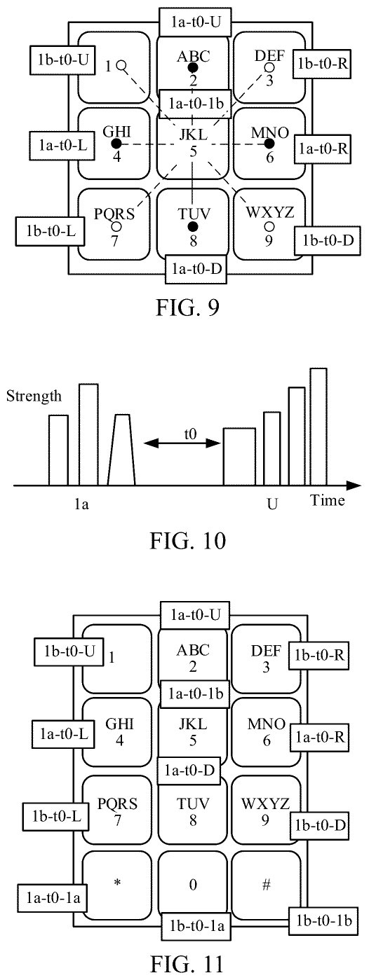

In some embodiments, if the first prefix waveform is represented by 1a, the second prefix waveform is represented by 1b, suffix waveforms corresponding to four orientations of up, down, left, and right are respectively represented by up, down, left, and right, and if the suffix waveform corresponding to the up orientation is represented by U, the suffix waveform corresponding to the down orientation is represented by D, the suffix waveform corresponding to the left orientation is represented by L, and the suffix waveform corresponding to the right orientation is represented by R, the vibration waveforms of various control elements in the grid obtained by the computer device based on a mode of combining the target prefix waveform and the suffix waveform is shown in FIG. 9. As shown in FIG. 9, a button corresponding to digit 5 is used as the anchor element because it is located at the central position of the grid. The vibration waveform corresponding to the button corresponding to digit 5 is obtained by two prefix waveforms (1a and 1b) based on a corresponding time interval t0. The vibration waveform may be specifically represented as 1a-t0-1b. A button corresponding to digit 2 is located at the up orientation of the central position, the vibration waveform obtained by performing vibration signal encoding on the button corresponding to digit 2 by using the prefix waveform and the suffix waveform may be represented as 1a-t0-U. The vibration waveform may be specifically shown as FIG. 10.

In some embodiments, the vibration waveform corresponding to the control element marked by a filled dot shown in FIG. 9 only includes the first prefix waveform 1a, while the vibration waveform corresponding to the control element marked by a hollow dot only includes the second prefix waveform 1b. For the control elements separated from the anchor element, the first prefix waveform and the second prefix waveform may be combined in different manners to form other vibration waveforms different from the vibration waveform corresponding to the anchor element, so that the other vibration waveforms may be associated with the control elements separated from the anchor element. Finally, a vibration signal encoding condition for grid-based control elements obtained by the computer device may be shown as FIG. 11.

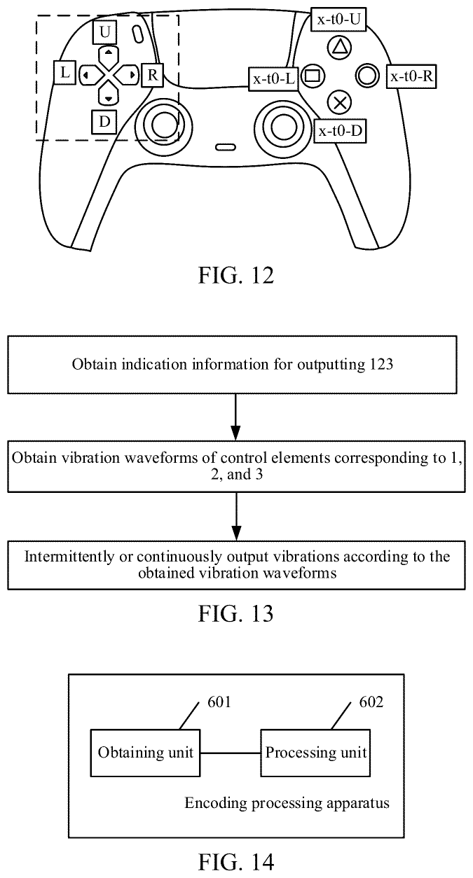

In some embodiments, the suffix waveform set in the computer device includes corresponding vibration waveforms configured for representing the up orientation, the down orientation, the left orientation, and the right orientation, so the computer device may directly express by using the vibration waveforms corresponding to the four orientations when the plurality of control elements are not in the grid layout in the target device. For an operation handle shown in FIG. 12, the vibration waveform corresponding to the up orientation (an up waveform, represented by U), the vibration waveform corresponding to the down orientation (a down waveform, represented by D), the vibration waveform corresponding to the left orientation (a left waveform, represented by L), and the vibration waveform corresponding to the right orientation (a right waveform, represented by R) correspond to different buttons, as shown in a part outlined by dashed lines in FIG. 12. If the corresponding control elements cannot be completely expressed by using the vibration waveforms corresponding to the four orientations, the prefix waveform and the suffix waveform may be combined for expressing. In this case, the computer device may obtain a target reference position correspondingly described by the target suffix waveform, obtain a target control element that has an orientation relationship as the target reference position with other control elements from the plurality of control elements, and then combine the target prefix waveform and the target suffix waveform based on a third time interval to generate a target combined waveform of the target control element. As shown in FIG. 12, the selected target prefix waveform is x, and the corresponding third time interval is t0. Similarly, the third time interval may be the same as or different from the first time interval (and/or the second time interval).

In some embodiments, suffix waveforms corresponding to the four orientations may express cast, south, west, and north in a navigation scenario, get-on and get-off prompt, approaching a destination, moving away from the destination in a scenario of taking a transportation tool, and moving directions of a virtual object in a game scenario, and so on.

After determining the vibration waveforms corresponding to various control elements and when target content corresponding to a target control element needs to be output, the computer device may obtain a reference control element required for generating the target content, and a vibration waveform corresponding to the reference control element. During outputting the target content, a vibration is output according to the vibration waveform corresponding to the reference control element, as shown in FIG. 13. Assuming that the target content that needs to be output currently is 123, the computer device confirms control elements 1, 2, and 3 and corresponding vibration waveforms respectively after obtaining an output request for 123. Then, vibration effects of various digit groups may be respectively output, or vibration effects of various digits may be continuously output based on the vibration waveforms.

In some embodiments, when the target control element is selected, the target content will be output. That is to say, after the target control element is selected, not only the target content will be output, but also the vibration will be output based on the vibration waveforms corresponding to the target control element.

In some embodiments, the computer device may determine layout information of the various control elements in the target device based on the positions of the various control elements in the target device when performing vibration signal encoding on the various control elements in the target device, and then may determine orientation indication information of any control element based on the layout information. In addition, the computer device may further obtain a corresponding expression form for content output based on the various control elements, so as to determine scenario indication information for describing the expression form, and then obtain vibration signal encoding information of the various control elements based on the scenario indication information and the orientation indication information in combination with vibration signal encoding. The orientation indication information is generally set in the computer device by using the vibration waveforms that strengthen or weaken continuously, or a change is represented by a decrease or an increase of a frequency, which facilitates perceiving a change of a vibration by a user, thereby reducing learning cost for vibration signal encoding. A corresponding user may implement a vibration signal encoding process of control elements in a large number of scenarios by only learning the scenario indication information, which effectively improves vibration signal encoding efficiency of the computer device on the control elements. A combined vibration signal encoding process implemented based on the scenario indication information and the orientation indication information also improves flexibility of performing the vibration signal encoding on the control elements.

Based on descriptions of the vibration signal encoding processing method embodiments described above, some embodiments further provide a vibration signal encoding processing apparatus. The vibration signal encoding processing apparatus may be a computer program (including program code) running in the computer device described above. The vibration signal encoding processing apparatus may be configured to perform the vibration signal encoding processing method described in FIG. 3. Referring to FIG. 14, the vibration signal encoding processing apparatus includes: an obtaining unit 601 and a processing unit 602.

The obtaining unit 601 is configured to obtain a plurality of control elements in a target device, and determine layout information of the plurality of control elements in the target device according to a device position of any control element in the target device.

The processing unit 602 is configured to determine scenario indication information corresponding to the plurality of control elements according to an expression form used by the target device to perform content output based on the plurality of control elements, and determine orientation indication information of any control element based on the layout information.

The processing unit 602 is further configured to perform vibration signal encoding on each of the plurality of control elements by using the scenario indication information and the orientation indication information to obtain vibration signal encoding information corresponding to the control element.

In some embodiments, the scenario indication information includes a prefix waveform, and the orientation indication information includes a suffix waveform. The processing unit 602 is further configured to:
combine the prefix waveform and the suffix waveform to generate one or more combined waveforms. One combined waveform is associated with one control element, and the combined waveform associated with the control element is taken as a vibration waveform of the corresponding control element.

In some embodiments, if there is at least one prefix waveform, and there is at least one suffix waveform, the processing unit 602 is further configured to:
select a target prefix waveform from the at least one prefix waveform, and select a target suffix waveform from the at least one suffix waveform; and
combine the target prefix waveform and the target suffix waveform to generate a target combined waveform.

In some embodiments, when the layout information indicates that the plurality of control elements are in a grid layout in the target device, the processing unit 602 is further configured to:
determine the control element that is located at a central position of a grid among the plurality of control elements in the grid layout as an anchor element, where the control element that is not located at the central position of the grid is a non-anchor element; and
select the target prefix waveform from the at least one prefix waveform, and select the target suffix waveform from the at least one suffix waveform based on an orientation relationship between the anchor element and the non-anchor element.

In some embodiments, the processing unit 602 is further configured to:
in a case that a target control element that needs to generate the vibration waveform is the anchor element, combine the target prefix waveform based on a first time interval to generate the target combined waveform of the target control element; or
in a case that a target control element that needs to generate the vibration waveform is the non-anchor element, combine the target prefix waveform and the target suffix waveform based on a second time interval to generate the target combined waveform of the target control element.

In some embodiments, when the target control element that needs to generate the vibration waveform is the anchor element, the obtained target prefix waveform includes a first prefix waveform and a second prefix waveform in the at least one prefix waveform. The target combined waveform of the target control element is generated after the first prefix waveform and the second prefix waveform are combined based on the first time interval to generate the target combined waveform of the target control element.

When the target control element that needs to generate the vibration waveform is the non-anchor element, the obtained target prefix waveform includes one target prefix waveform and the obtained target suffix waveform includes one target suffix waveform. The target combined waveform of the target control element is generated after the one obtained target prefix waveform and the one obtained target suffix waveform are combined based on the second time interval.

In some embodiments, the processing unit 602 is further configured to:
select, from the at least one prefix waveform, the prefix waveform that matches the expression form used by the target device to perform content output as the target prefix waveform.

In some embodiments, one suffix waveform corresponds to one reference position relationship. The processing unit 602 is further configured to:
select a suffix waveform with a corresponding reference position relationship that is the same as the orientation relationship from the at least one suffix waveform based on the orientation relationship between the anchor element and the non-anchor element.

The selected suffix waveform is the target suffix waveform.

In some embodiments, the reference position relationship includes one or more of an up orientation, a down orientation, a left orientation, and a right orientation. The at least one suffix waveform includes: a suffix waveform corresponding to any one of the up orientation, the down orientation, the left orientation, and the right orientation.

A vibration strength of the suffix waveform corresponding to the up orientation gradually increases, a vibration strength of the suffix waveform corresponding to the down orientation gradually decreases, a vibration frequency of the suffix waveform corresponding to the right orientation gradually increases, and a vibration frequency of the suffix waveform corresponding to the left orientation gradually decreases.

In some embodiments, when the plurality of control elements are not in a grid layout in the target device, the processing unit 602 is further configured to:
obtain a target reference position correspondingly described by the target suffix waveform;
obtain a target control element that has an orientation relationship with other control elements as the target reference position from the plurality of control elements; and
combine the target prefix waveform and the target suffix waveform based on a third time interval to generate the target combined waveform of the target control element.

In some embodiments, the obtaining unit 601 is further configured to obtain a total element quantity corresponding to the plurality of control elements, and determine a waveform quantity N of required target prefix waveforms and a waveform quantity M of required target suffix waveforms according to the total element quantity. Both N and M are positive integers.

The obtaining unit 601 is further configured to obtain N target prefix waveforms and M target suffix waveforms. A quantity of the combined waveforms obtained by combining the N target prefix waveforms and the M target suffix waveforms is greater than or equal to the total element quantity.

In some embodiments, the obtaining unit 601 is further configured to obtain a total element quantity corresponding to the plurality of control elements, and obtain one prefix waveform as a basic prefix waveform and M target suffix waveforms. M is a positive integer.

The processing unit 602 is further configured to perform splitting processing on the basic prefix waveform to obtain N split waveforms according to the total element quantity and the waveform quantity M of the target suffix waveforms. A quantity of the combined waveforms obtained by combining the N split waveforms and the M target suffix waveforms is greater than or equal to the total element quantity. N is greater than 1, and N is a positive integer.

The processing unit 602 is further configured to determine the N split waveforms as the target prefix waveforms.

In some embodiments, the processing unit 602 is further configured to randomly combine the M target suffix waveforms and the basic prefix waveform to obtain combined reference waveforms.

The processing unit 602 is further configured to associate one obtained combined reference waveform with one control element in a case that the quantity of the obtained combined reference waveforms is greater than or equal to the total element quantity, where different control elements being associated with different combined reference waveforms; and
perform splitting processing on the basic prefix waveform according to the total element quantity and the waveform quantity M of the target suffix waveforms in a case that the quantity of the obtained combined reference waveforms is less than the total element quantity.

In some embodiments, the processing unit 602 is further configured to obtain a reference control element required for generating target content corresponding to a target control element, and a vibration waveform corresponding to the reference control element when the target content corresponding to the target control element needs to be output.

The processing unit 602 is further configured to output a vibration according to the vibration waveform corresponding to the reference control element during outputting the target content.

In some embodiments, the obtaining unit 601 may determine layout information of various control elements in the target device based on the positions of the various control elements in the target device when performing vibration signal encoding on the various control elements in the target device, and then the processing unit 602 may determine orientation indication information of any control element based on the layout information. In addition, the obtaining unit 601 may further obtain a corresponding expression form for content output based on the various control elements, so that the processing unit 602 may determine scenario indication information for describing the expression form, and then obtain vibration signal encoding information of the various control elements based on the scenario indication information and the orientation indication information in combination with vibration signal encoding. The orientation indication information is generally set by using the vibration waveforms that strengthen or weaken continuously, or a change is represented by a decrease or an increase of a frequency, which facilitates perceiving a change of a vibration by a user, thereby reducing learning cost for performing vibration signal encoding. A corresponding user may implement a vibration signal encoding process of control elements in a large number of scenarios by only learning the scenario indication information, which effectively improves vibration signal encoding efficiency of the control elements. A combined vibration signal encoding process implemented based on the scenario indication information and the orientation indication information also improves flexibility of performing the vibration signal encoding on the control elements.

A person skilled in the art would understand that these “units” could be implemented by hardware logic, a processor or processors executing computer software code, or a combination of both. The “units” may also be implemented in software stored in a memory of a computer or a non-transitory computer-readable medium, where the instructions of each unit are executable by a processor to thereby cause the processor to perform the respective operations of the corresponding unit.

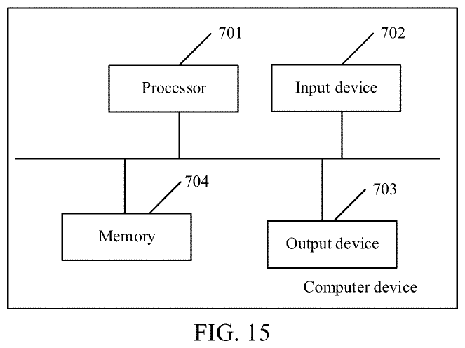

Refer to FIG. 15, which is a schematic block diagram of a computer device according to some embodiments. The computer device in some embodiments as shown in FIG. 15 may include: one or more processors 701, one or more input devices 702, one or more output devices 703, and a memory 704. The processor 701, the input device 702, the output device 703, and the memory 704 described above are connected through a bus. The memory 704 is configured to store a computer program. The computer program includes program instructions. The processor 701 is configured to execute the program instructions stored in the memory 704.

The memory 704 may include a volatile memory, for example, a random-access memory (RAM). The memory 704 may include a non-volatile memory, for example, a flash memory, a solid-state drive (SSD), and the like. The memory 704 may further include a combination of the types of memories described above.

The processor 701 may be a central processing unit (CPU). The processor 701 may further include a hardware chip. The hardware chip described above may be an application-specific integrated circuit (ASIC), a programmable logic device (PLD), or the like. The PLD may be a field-programmable gate array (FPGA), a generic array logic (GAL), or the like. The processor 701 may be a combination of the structures described above.

In some embodiments, the memory 704 is configured to store a computer program. The computer program includes program instructions. The processor 701 is configured to execute the program instructions stored in the memory 704 to implement operations of the corresponding method as shown in FIG. 3.

In some embodiments, the processor 701 is configured to call the program instructions to perform the following operations:
obtaining a plurality of control elements in a target device, and determining layout information of the plurality of control elements in the target device according to a device position of any control element in the target device;
determining scenario indication information corresponding to the plurality of control elements according to an expression form used by the target device to perform content output based on the plurality of control elements, and determining orientation indication information of any control element based on the layout information; and
performing vibration signal encoding on each of the plurality of control elements by using the scenario indication information and the orientation indication information to obtain vibration signal encoding information corresponding to the control element.

Some embodiments provide a computer program product or a computer program. The computer program product or the computer program includes computer instructions. The computer instructions are stored in a computer-readable storage medium. A processor of a computer device reads the computer instructions from the computer-readable storage medium, and the processor executes the computer instructions, so that the computer device performs the method embodiment as shown in FIG. 3 described above. The computer readable storage medium may be a magnetic disc, an optical disc, a read-only memory (ROM), a random access memory (RAM), or the like.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A vibration signal encoding processing method, performed by a computer device, comprising:
obtaining a plurality of control elements in a target device, and determining layout information of the plurality of control elements in the target device according to a device position of any control element of the plurality of control elements in the target device;
determining scenario indication information corresponding to the plurality of control elements according to an expression form used by the target device to perform content output based on the plurality of control elements, and determining orientation indication information of any control element based on the layout information, the expression form comprising a digit form, a letter form, and a character form, the scenario indication information indicating an expression form of output content of a corresponding control element and the orientation indication information indicating a relative position of the corresponding control element; and
performing vibration signal encoding on each of the plurality of control elements based on the scenario indication information and the orientation indication information to obtain vibration signal encoding information corresponding to each of the plurality of control elements, the vibration signal encoding information indicating a vibration mode of a vibration motor of the computer device.

2. The vibration signal encoding processing method according to claim 1, wherein the scenario indication information is a prefix waveform and the orientation indication information is a suffix waveform; and
wherein the performing comprises:
combining the prefix waveform and the suffix waveform to generate one or more combined waveforms, wherein one combined waveform is associated with one control element, and the combined waveform associated with the control element is used as a vibration waveform of the corresponding control element.

3. The vibration signal encoding processing method according to claim 2, wherein a quantity of prefix waveforms is at least one, and a quantity of suffix waveforms is at least one; and
combining the prefix waveform and the suffix waveform comprises:
selecting a target prefix waveform from the at least one prefix waveform, and selecting a target suffix waveform from the at least one suffix waveform, the target prefix waveform being a prefix waveform that matches the expression form used by the target device to perform content output, and the target suffix waveform being a suffix waveform that matches position information of the control element; and
combining the target prefix waveform and the target suffix waveform to generate a target combined waveform.

4. The vibration signal encoding processing method according to claim 3, wherein the layout information indicates that the plurality of control elements are in a grid layout in the target device; and
the selecting comprises:
determining a control element that is located at a central position of a grid among the plurality of control elements in the grid layout as an anchor element, wherein a control element that is not located at the central position of the grid is a non-anchor element; and
selecting the target suffix waveform from the at least one suffix waveform based on an orientation relationship between the anchor element and the non-anchor element.

5. The vibration signal encoding processing method according to claim 4, wherein the combining the target prefix waveform and the target suffix waveform to generate the target combined waveform comprises:
based on a target control element that generates the vibration waveform being the anchor element, combining the target prefix waveform based on a first time interval to generate the target combined waveform of the target control element.

6. The vibration signal encoding processing method according to claim 5, wherein the combining the target prefix waveform based on the first time interval to generate the target combined waveform of the target control element comprises:
obtaining a first prefix waveform and a second prefix waveform in the at least one prefix waveform comprised in the target prefix waveform; and
combining the first prefix waveform and the second prefix waveform based on the first time interval to generate the target combined waveform of the target control element.

7. The vibration signal encoding processing method according to claim 4, wherein the combining the target prefix waveform and the target suffix waveform to generate a target combined waveform comprises:
based on a target control element that generates the vibration waveform being the non-anchor element, combining the target prefix waveform and the target suffix waveform based on a second time interval to generate the target combined waveform of the target control element.

8. The vibration signal encoding processing method according to claim 7, wherein the combining the target prefix waveform and the target suffix waveform based on the second time interval to generate the target combined waveform of the target control element comprises:
obtaining the target prefix waveform, and obtaining the target suffix waveform; and
combining the target prefix waveform and the target suffix waveform based on the second time interval to generate the target combined waveform of the target control element.

9. The vibration signal encoding processing method according to claim 4, wherein the selecting the target prefix waveform from the at least one prefix waveform comprises:
selecting, from the at least one prefix waveform, a prefix waveform that matches the expression form used by the target device to perform content output as the target prefix waveform.

10. The vibration signal encoding processing method according to claim 4, wherein one suffix waveform corresponds to one reference position relationship; and
the selecting the target suffix waveform from the at least one suffix waveform based on the orientation relationship between the anchor element and the non-anchor element comprises:
selecting, from the at least one suffix waveform, a suffix waveform with a corresponding reference position relationship that is the same as the orientation relationship based on the orientation relationship between the anchor element and the non-anchor element, wherein
the selected suffix waveform is the target suffix waveform.

11. The vibration signal encoding processing method according to claim 10, wherein the reference position relationship comprises one or more of an up orientation, a down orientation, a left orientation, and a right orientation; the at least one suffix waveform comprises: a suffix waveform corresponding to any one of the up orientation, the down orientation, the left orientation, and the right orientation, wherein
a vibration strength of the suffix waveform corresponding to the up orientation gradually increases, a vibration strength of the suffix waveform corresponding to the down orientation gradually decreases, a vibration frequency of the suffix waveform corresponding to the right orientation gradually increases, and a vibration frequency of the suffix waveform corresponding to the left orientation gradually decreases.

12. The vibration signal encoding processing method according to claim 3, wherein the plurality of control elements are not in a grid layout in the target device; and
the combining the target prefix waveform and the target suffix waveform to generate the target combined waveform comprises:
obtaining a target reference position correspondingly described by the target suffix waveform;
obtaining a target control element that has an orientation relationship with other control elements as the target reference position from the plurality of control elements; and
combining the target prefix waveform and the target suffix waveform based on a third time interval to generate the target combined waveform of the target control element.

13. The vibration signal encoding processing method according to claim 2, further comprising:
obtaining a total element quantity corresponding to the plurality of control elements, and determining a waveform quantity N of required target prefix waveforms and a waveform quantity M of required target suffix waveforms according to the total element quantity, wherein both N and M are positive integers; and
obtaining N target prefix waveforms and M target suffix waveforms, wherein a quantity of the combined waveforms obtained by combining the N target prefix waveforms and the M target suffix waveforms is greater than or equal to the total element quantity.

14. The vibration signal encoding processing method according to claim 2, further comprising:
obtaining a total element quantity corresponding to the plurality of control elements, and obtaining one prefix waveform as a basic prefix waveform and M target suffix waveforms, M being a positive integer;
performing splitting on the basic prefix waveform to obtain N split waveforms according to the total element quantity and the waveform quantity M of the target suffix waveforms, a quantity of the combined waveforms obtained by combining the N split waveforms and the M target suffix waveforms being greater than or equal to the total element quantity, N being greater than 1, and N being a positive integer; and
determining the N split waveforms as target prefix waveforms.

15. The vibration signal encoding processing method according to claim 14, further comprising:
randomly combining the M target suffix waveforms and the basic prefix waveform to obtain combined reference waveforms; and
associating one obtained combined reference waveform with one control element based on the quantity of the obtained combined reference waveforms being greater than or equal to the total element quantity, different control elements being associated with different combined reference waveforms.

16. The vibration signal encoding processing method according to claim 15, further comprising:
triggering performing splitting on the basic prefix waveform according to the total element quantity and the waveform quantity M of the target suffix waveforms based on the quantity of the obtained combined reference waveforms being less than the total element quantity.

17. The vibration signal encoding processing method according to claim 2, further comprising:
obtaining a reference control element required for generating target content corresponding to a target control element, and a vibration waveform corresponding to the reference control element; and
outputting a vibration according to the vibration waveform corresponding to the reference control element during outputting the target content.

18. A vibration signal encoding processing apparatus comprising:
at least one memory configured to store program code; and
at least one processor configured to read the program code and operate as instructed by the program code, the program code comprising:
obtaining code configured to cause at least one of the at least one processor to obtain a plurality of control elements in a target device, and determine layout information of the plurality of control elements in the target device according to a device position of any control element of the plurality of control elements in the target device; and
processing code configured to cause at least one of the at least one processor to:
determine scenario indication information corresponding to the plurality of control elements according to an expression form used by the target device to perform content output based on the plurality of control elements, and determine orientation indication information of any control element based on the layout information, the expression form comprising a digit form, a letter form, and a character form, the scenario indication information indicating an expression form of output content of a corresponding control element and the orientation indication information indicating a relative position of the corresponding control element; and
perform vibration signal encoding on each of the plurality of control elements based on the scenario indication information and the orientation indication information to obtain vibration signal encoding information corresponding to each of the plurality of control elements, the vibration signal encoding information indicating a vibration mode of a vibration motor of a computer device.

19. The vibration signal encoding processing apparatus according to claim 18, wherein the scenario indication information is a prefix waveform and the orientation indication information is a suffix waveform; and
wherein the performing code is further configured to cause at least one of the at least one processor to combine the prefix waveform and the suffix waveform to generate one or more combined waveforms, wherein one combined waveform is associated with one control element, and the combined waveform associated with the control element is used as a vibration waveform of the corresponding control element.

20. A non-transitory computer-readable storage medium storing computer code which, when executed by at least one processor, causes the at least one processor to at least:
obtain a plurality of control elements in a target device, and determine layout information of the plurality of control elements in the target device according to a device position of any control element of the plurality of control elements in the target device;
determine scenario indication information corresponding to the plurality of control elements according to an expression form used by the target device to perform content output based on the plurality of control elements, and determine orientation indication information of any control element based on the layout information, the expression form comprising a digit form, a letter form, and a character form, the scenario indication information indicating an expression form of output content of a corresponding control element and the orientation indication information indicating a relative position of the corresponding control element; and
perform vibration signal encoding on each of the plurality of control elements based on the scenario indication information and the orientation indication information to obtain vibration signal encoding information corresponding to each of the plurality of control elements, the vibration signal encoding information indicating a vibration mode of a vibration motor of a computer device.
